(19) United States
(12) Patent Application Publication
(10) Pub. No.: US 2017/0236238 A1
(43) Pub. Date: Aug. 17, 2017

(54) SYSTEMS, DEVICES, AND METHODS FOR COMMUNICATING FOOD PRODUCT SLICE THICKNESSES

(71) Applicant: Robert W. Bruce, Loveland, OH (US)

(72) Inventor: Robert W. Bruce, Loveland, OH (US)

(21) Appl. No.: 15/360,490

(22) Filed: Nov. 23, 2016

Related U.S. Application Data
(60) Provisional application No. 62/259,751, filed on Nov. 25, 2015.
(60) Provisional application No. 62/265,456, filed on Dec. 10, 2015.

(51) Int. Cl. G06Q 90/00; B26D 7/26

(52) U.S. Cl. CPC G06Q 90/00; B26D 7/2628; B26D 2210/02

(57) ABSTRACT

Systems, methods and sales display devices that are capable of providing customers with identifying features representative of varying thicknesses of food products slices available for purchase, and with which customers can place orders for sliced food products having a desired slice thickness.

### CROSS REFERENCE TO RELATED APPLICATIONS

This application claims the benefit of U.S. Provisional Application No. 62/259/751, filed Nov. 25, 2015, and U.S. Provisional Application No. 62/265/456, filed Dec. 10, 2015. The contents of these prior applications are incorporated herein by reference.

### BACKGROUND OF THE INVENTION

The present invention generally relates to systems, methods and devices used in sales promotions. The invention particularly relates to sales display systems and devices that provide customers with identifying features representative of varying thicknesses of sliced food products available for purchase.

Cutting and slicing machines of types used for slicing food products are commonly equipped with thickness settings that may be used by an operator to provide food product slices over a continuous range, for example, about 0 to about 3 mm (about 0 to about 0.120 inch). Because of the flexible nature of meats, cheeses, and certain other food products, the accuracy of the thickness setting may be within about plus or minus ten percent of the intended thickness. For example, a slicing machine having thickness settings of 0.5, 1.0, 1.5, 2.0, 2.5, and 3.0 mm (about 0.020, 0.040, 0.060, 0.080, 0.100, and 0.120 inch) may produce food product slices in ranges of about 0.45 to 0.55, 0.9 to 1.1, 1.35 to 1.65, 0.18 to 2.2, 2.25 to 2.75, and 2.7 to 3.3 mm. Based on the skill of the operator and the continuously variable machine setting, any desirable thickness over the operating range of the equipment can often be achieved.

At delicatessen (deli) counters and sliced-meat departments in the U.S., the slice thicknesses of meats and cheeses are often described as shaved, very thin, thin, regular, and thick. Because of the subjective nature of these descriptions, the attendant will sometimes show the customer a first slice of food product before slicing the entire order so that the customer may judge the thickness of the slice. Often this slice is offered as a free sample to the customer. The result of this process is wasted time, additional costs for the vendor, and, potentially, dissatisfaction of the customer who still may not have received the exact thickness desired.

Accordingly, there is an ongoing desire for methods and means for communicating to customers the various thicknesses of food product slices available for purchase, and in particular methods and means that could avoid the additional cost and time involved in offering free samples to customers.

### BRIEF DESCRIPTION OF THE INVENTION

The present invention provides systems, methods and sales display devices that are capable of providing customers with identifying features representative of varying thicknesses of food products slices available for purchase without necessitating the offering of free samples to the customers.

According to one aspect of the invention, a sales display device includes a plurality of identifying features each having a thickness indicative of a thickness of a food product slice, and means for individually identifying each of the plurality of identifying features.

According to another aspect of the invention, a method for purchasing food products provided in the form of one or more slices includes providing a device to a customer wherein the device has a plurality of identifying features each having a thickness representative of a thickness of which slices of the food products may be produced, and means for individually identifying each of the plurality of identifying features. The customer compares the relative thicknesses of the plurality of identifying features, determines a desired thickness for slices of the food product based on the relative thicknesses of the plurality of identifying features, and communicates the desired thickness based on the identifying means. The food products may then be cut into slices such that the slices have a thickness based on the desired thickness communicated by the customer.

According to another aspect of the invention, a food product ordering system comprises an electronic device for placing an order for a sliced food product and a computer wirelessly connected to the electronic device for receiving the order for the sliced food product. The electronic device comprises a plurality of identifying features each having a thickness indicative of a slice thickness of the sliced food product, and means for selecting a food product, weight of the food product, and one of the identifying features to select one of the slice thicknesses.

Technical effects of sales display systems, devices, and methods of types described above preferably include the ability to communicate available food product slices to a customer without the need to provide the customer with a free sample of the food product slice. Instead, the systems, devices, and methods enable a customer to compare the relative thicknesses of the identifying features of the device and then communicate the desired thickness of the food product slice to an attendant by making reference to the identifying features of the device. Advantages of using such devices include the increased likelihood that a customer will receive food product slices of the thickness desired by the customer, the ability to more easily interpolate and extrapolate slice thicknesses based on the measurements and coding provided on the devices, and the ability to more rapidly and accurately fill a customer's order with less effort required by the customer and attendant.

Other aspects and advantages of this invention will be further appreciated from the following detailed description.

### BRIEF DESCRIPTION OF THE DRAWINGS

FIG. 1 contains images representing sales display devices capable of use in systems that can be used by customers to order food product slices of various thicknesses available for purchase in accordance with certain nonlimiting aspects of this invention.

FIG. 2 represent photocopies of sales display devices such as of a type shown in FIG. 1, and evidence the ability of a photocopy to be used in an essentially identical manner as the embodiments represented in FIG. 1.

FIGS. 3, 4 and 5 schematically represent additional sales display devices capable of use in systems that can be used by customers to order food product slices of various thicknesses available for purchase in accordance with additional nonlimiting aspects of this invention.

### DETAILED DESCRIPTION OF THE INVENTION

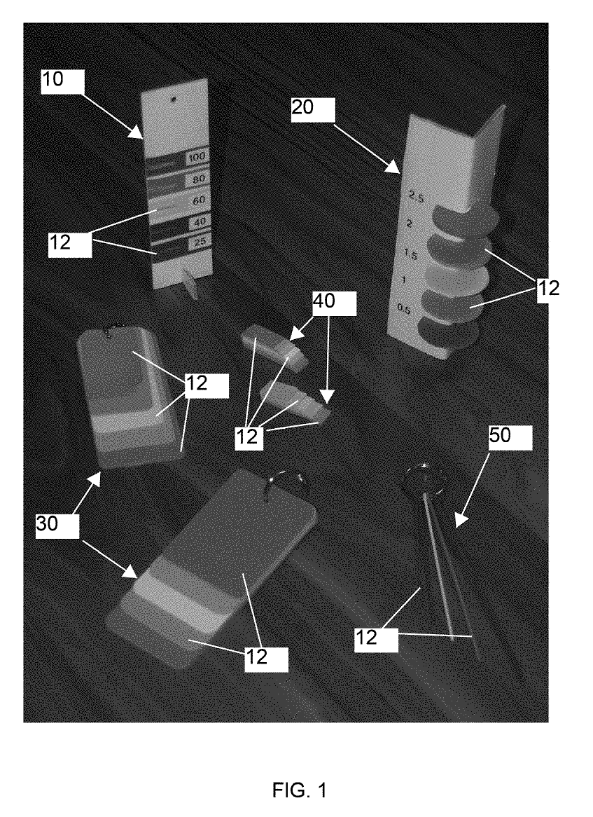

FIG. 1 represents various nonlimiting embodiments of sales display devices 10, 20, 30, 40, and 50 suitable for use in systems adapted to communicate to a customer various thicknesses of product slices available for purchase, for example at a deli counter or a sliced-meat department. These devices 10, 20, 30, 40, and 50 provide customers with the ability to gauge the thickness of a slice of food product prior to the product being sliced by an attendant. The devices 10, 20, 30, 40, and 50 are capable of communicating various available slice thicknesses visually, by touch, or both such that the customer may compare all available options. Upon determining a desired slice thickness, the customer may communicate the desired slice thickness to the attendant using any of multiple identifying features 12 provided on the device 10, 20, 30, 40, and 50, or by providing the attendant with a portion of the device 10, 20, 30, 40, or 50 carrying one or more identifying features 12 indicative of the desired slice thickness. Alternatively, and particularly if the slice thickness adjuster of a slicer is not equipped with thickness indicators, the customer and attendant can make thickness comparisons using as references one or more devices 10, 20, 30, 40, and 50 of different thicknesses, which may avoid the practice of the attendant providing the customer with a sample slice. While the identifying features 12 of the sales display devices 10, 20, 30, 40, and 50 are represented as comprising means for identifying individual slice thicknesses by color and, in some cases, also with numerical values and/or physical attributes, it is foreseeable that functionally-equivalent identifying means could be used to distinguish between the individual slice thicknesses, such as numbers, patterns, shapes, etc.

Regardless of the specific identifying features 12 and identifying means incorporated onto the sales display devices 10, 20, 30, 40, and 50 shown in FIG. 1, the identifying features 12 are preferably aligned and arranged side by side on the devices 10, 20, 30, 40, and 50 in a logical order, e.g., from thinnest to thickest, for comparison and to facilitate handling and communication. The identifying features 12 of the devices 10, 20, 30, 40, and 50 include physical attributes individually associated with different colors. In particular, the identifying features 12 of the devices 10, 20, 30, 40, and 50 include slots, disks, cards, tiers, and rods, respectively. The features 12 of the devices 20, 30 and 50 are separate articles held together in some manner, for example, with slots (device 20) or rings (devices 30 and 50), though other securement means are possible, for example, fasteners such as rivets, grommets, eyelets, staples, chains, glues, etc. The features 12 of the devices 10 and 40 are integral physical attributes of single articles, for example, slots formed in a card (device 10) or tiers (device 40) machined, extruded, or otherwise formed to have different widths or thicknesses. By placing the features 12 in proximity to each other, a customer can easily compare their relative thicknesses and determine a desired product slice thickness. Colors that can be readily distinguished and identified include red, orange, yellow, green, blue, and purple, though other colors, combinations, patterns (such as checkered), etc., can be used. The colors of the features 12 are shown as arranged in the order of their wavelengths in the electromagnetic spectrum to promote the intuitiveness of the devices 10, 20, 30, 40, and 50. The features 12 of the devices 10 and 20 further include numerical values to facilitate communication. The individual features 12 of the devices 10, 20, 30, 40, and 50 may have any outline, shape, and/or dimensions that may be suitable under various circumstances. For example, an individual identifying feature 12 may have a size as small as 1×0.5 inch (about 2.5×1.3 cm), or as large as 6×2.5 inches (about 15×6.3 cm), with larger sizes facilitating the display of a logo or promotion.

The devices 10, 20, 30, 40, and 50 are preferably formed of materials that can be cleaned, disposed of, recycled, or a combination thereof. Such materials include, but are not limited to, paper, polymers (for instance polyethylene, polypropylene, nylon, etc.), metals, and composite materials. The materials may be either a solid or foam. The devices 10, 20, 30, 40, and 50 and their features 12 can be relatively small, low cost, and hygienic for advertising or promotion, while providing a simple means of effectively communicating a desired slice thickness among a range of slice thicknesses that may be available for slices of a particular food product.

As noted above, the display device 10 in FIG. 1 comprises a card, for example, a stand, rack, or other type of upright support, and its individual features 12 are slots formed along an edge of the card. In the nonlimiting embodiment represented in FIG. 1, the slots range in width from about 0.025 to 0.100 inch (about 0.6 to 2.5 mm) wide. Each slot is located within a field or background of a specific color and number identifying the slot and a product slice thickness corresponding to the width of each slot. A customer may determine a desired slice thickness by inspecting the slots, and then communicate the desired slice thickness to an attendant by identifying the corresponding color or number. As evident from FIG. 1, the slots are arranged in a logical order of increasingly wider slots from bottom to top. Based on knowledge of this logical order, a customer may also communicate a desired slice thickness by requesting a thickness that is less than or greater than a particular field color or number associated with a slot, or a thickness that lies between a consecutive pair of field colors or numbers associated with a consecutive pair of slots.

The display device 20 in FIG. 1 also comprises a card, for example, a stand, rack, or other type of upright support. The device 20 differs in part from the device 10 as a result of the features 12 being in the form of disks of different colors and thicknesses protruding from the card, wherein each disk corresponds to a different product slice thickness. In the nonlimiting embodiment represented in FIG. 1, the disks are indicated as having individual thicknesses ranging from about 0.5 to 2.5 mm (about 0.020 to 0.100 inch). Although represented as circular, the disks may be of any shape. The disks may be removable from the card, in which case the disks may be received in slots formed in the card and identified by different colors, numbers, patterns, etc., that preferably match the identifying aspects of the disks. As with the embodiment of FIG. 1, the disks are arranged in a logical order of increasingly thicker disks from bottom to top, enabling a customer to request a slice thickness that is less than or greater than a particular disk color or number or between a consecutive pair of disk colors or numbers. In FIG.1, the disks are formed of a plastic material.

As previously noted, the features 12 of two devices 30 represented in FIG. 1 are in the form of collections of cards or other sheet-like panels, each of a different color, size (e.g., lengths ranging from about 2.5 to about 6 inches (about 6 to 15 cm)), and thickness (e.g., ranging from about 0.025 to 0.120 inch (about 0.6 to 3 mm)), corresponding to different slice thicknesses that may be available. Thicknesses and/or other identifying information may be printed on each card. The cards are shown as loosely secured to one another with a ring (or similar securing means) that passes through a hole within each card, enabling each device 30 to be connected to a stationary object to prevent misplacement. As with previously described embodiments, the cards are arranged in a logical order, here increasingly thicker cards from top to bottom, to enable customers to request a slice thickness that is less than or greater than a particular card color (thickness) or between a consecutive pair of card colors (thicknesses). The cards may be formed of a wide variety of materials, including but not limited to plastic or metallic materials.

The features 12 of two devices 40 represented in FIG. 1 comprise tiers or other stack-like structures, each also having a different color, size (e.g., lengths ranging from about 0.5 to 2 inches (about 1.3 to 5 cm)), and thickness (e.g., ranging from 0.020 to 0.120 inch (about 0.5 to 3 mm), corresponding to different slice thicknesses that may be available. Thicknesses and/or other identifying information may be printed on each tier. The tiers may be formed of a wide variety of materials, including but not limited to plastic or metallic materials. In the embodiment represented in FIG. 1, the tiers are panels, cards, or sheets that may be removable from one another and formed of a disposable or recyclable material, such that each device 40 may be intended for a single use. For example, the tiers may be made of a paper sheets and adhesively secured to one another by glue or other securing means, peeled apart from each other during the course of assisting a customer, and discarded once the customer has made a purchase. As with previously described embodiments, the tiers are arranged in a logical order, here increasingly thicker tiers from top to bottom, to enable customers to request a slice thickness that is less than or greater than a particular tier color (thickness) or between a consecutive pair of tier colors (thicknesses).

The features 12 of the device 50 represented in FIG. 1 comprise a collection of rods, each with a different color, length, and thickness (e.g., ranging from 0.025 to 0.120 inch (about 0.6 to 3 mm)), corresponding to different slice thicknesses that may be available. Thicknesses and/or other identifying information may be printed on each rod. The rods are shown as secured to one another with a ring that passes through a hole within each rod, enabling the device 50 to be connected to a stationary object to prevent misplacement. As with previously described embodiments, the rods are arranged in a logical order, here increasingly thicker rods from left to right, to enable customers to request a slice thickness that is less than or greater than a particular rod color (thickness) or between a consecutive pair of rod colors (thicknesses). The rods may be formed of a wide variety of materials, including but not limited to plastic or metallic materials.

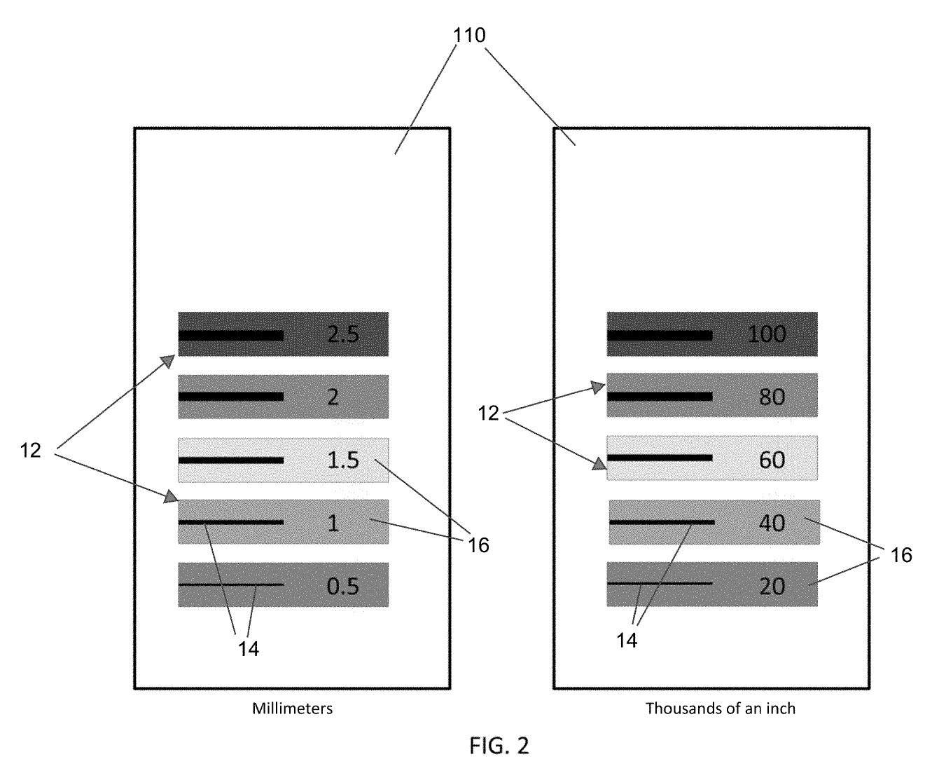

An image of any of the sales display devices 10, 20, 30, 40, and 50 shown in FIG. 1 could also be used to communicate to a customer various thicknesses of product slices available for purchase. FIG. 2 shows two color photocopies 110 of two devices similar to the sales display device 10 of FIG. 1 produced with a standard photocopier on a sheet of white stock paper, and evidences that the photocopies 110 could be used as gauges in place of the original device 10. In place of the slots of the original device 10, the photocopies 110 can be produced with black paper overlying the device 10 to result in dark bands or bars 14 imaged from the slots in the original device 10. The black bands 14, which are located within the same color fields 16 used by the original device 10 as identifying means, can then be used to represent various thicknesses of product slices available for purchase. Though the photocopies 110 are preferably in color, it is foreseeable that a grayscale image could also be useful. The photocopies 110 shown in FIG. 2 could alternatively utilize black dots as the thickness indicating features 12. A readily apparent advantage of a photocopied image is the minimal cost of their reproduction, such that each photocopy 110 can be a single-use disposable item.

It should be apparent from the foregoing that the sales display devices 10, 20, 30, 40, and 50 and photocopies 110 are nonlimiting examples of the present invention. It is foreseeable and within the scope of the invention that a sales display device could incorporate some or all of the various aspects of the devices 10, 20, 30, 40, and 50, and/or may include indicating features 12 not represented in FIG. 1. The drawings disclose certain dimensions, materials, and structures for the various devices 10, 20, 30, 40, and 50 that are exemplary, but are otherwise not necessarily limitations to the scope of the invention. While the devices 10, 20, 30, 40, and 50 have been described as having specific thickness dimensions, it should be clear that theoretically any desired slice thickness between the disclosed thickness values and outside the stated thickness ranges can be achieved by interpolation and extrapolation.

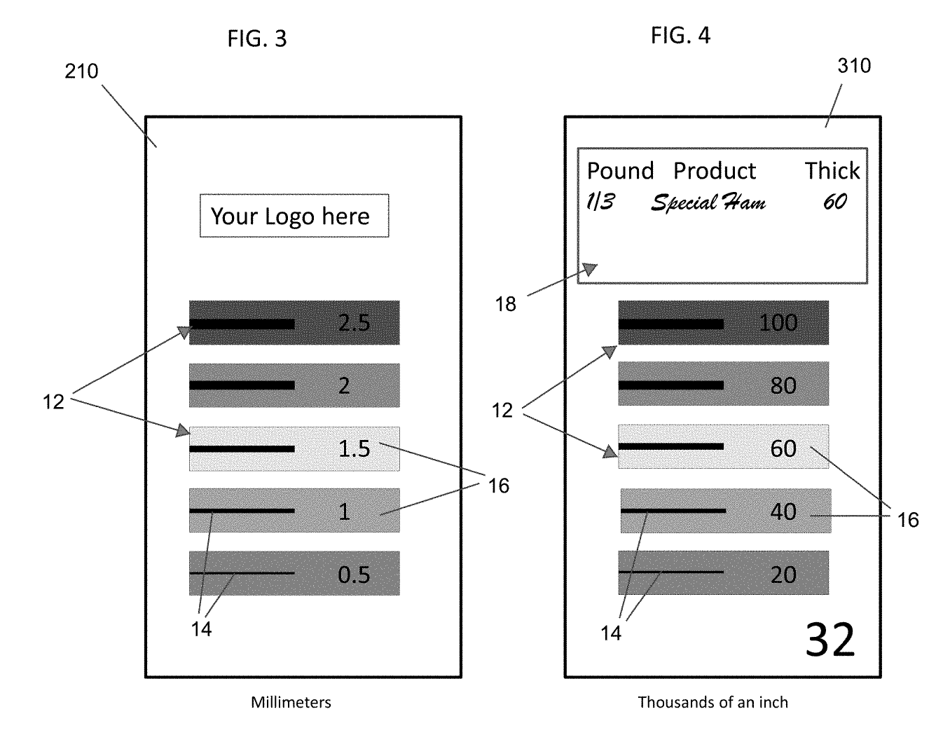

FIGS. 3 and 4 schematically represent handheld electronic devices 210 and 310 that are capable of use in electronic ordering systems that can be used by customers to order food product slices of various thicknesses in accordance with additional nonlimiting aspects of this invention. The electronic device 210 may be a touch pad or other handheld device by which a customer is able to select a slice thickness by selecting one of a number of displayed indicating features 12, each represented as a dark band or bar 14 within an identifying means comprising a color field 16 and identified with a numerical value for the slice thickness. The electronic device 310 further enables a customer to select the type and weight of a product to be purchased, which appear in a display 18 near the top of the device 310. With these devices 210 and 310, a computer system can be employed to facilitate electronic ordering. In some instances, a customer may enter their name and pay for their order at check out. Alternatively, a customer may enter their store membership number on the device 210 or 310 and pay for the sliced product at check out. The devices 210 and 310 may further incorporate a credit or debit card reader that enables a customer to pay for a sliced product when the order is placed. In each case, the time of the order can be automatically recorded. The display 18 on the device 310 may allow a customer to view a complete list of products in alphabetical order, categorized by type (e.g., beef, kosher, etc.), brands, conditions (e.g., rare, well done, etc.) and product availability. The devices 210 and 310 are preferably wirelessly connected to a computer that records the time when the order was placed, issues an order number, and optionally records the time that the order was filled. A printed confirmation of the order, including details such as time, order number, product, weight, slice thickness, etc., may be printed so that the customer has a record of the purchase. When the customer's order is ready, the attendant can notify the customer using an order number (lower righthand corner of FIG. 4) or the customer's name, either of which may be entered on the device 210 and/or 310.

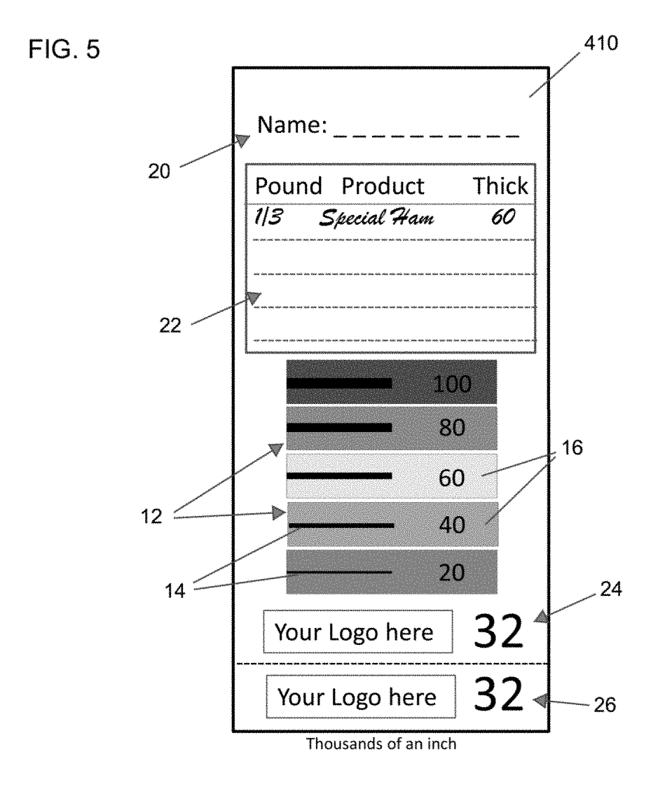

Certain features of the devices 210 and 310 described above can be realized without the use of a computer, for example, through a device 410 represented in FIG. 5 as an order form on which a customer can select a slice thickness by selecting one of a number of indicating features 12, each represented as a dark band or bar 14 within an identifying means comprising a color field 16 and identified with a numerical value for the slice thickness. The customer can enter their name and write down the product, weight, slice thickness, etc., in form fields 20 and 22, after which the device 410 can simply be handed to an attendant to process the order. The order form can incorporate an order number 24 and may have a tear-off strip 26 with the same order number that the customer can retain after submitting the order form to an attendant. A time stamp (not shown) may also be incorporated on the form. When the customer's order is ready, the attendant can notify the customer using the order number 24 or customer's name 20 that was entered on the device 410. It should be appreciated that, though the device 410 does not have all of the conveniences of the electronic devices 210 and 310, all three devices 210, 310 and 410 are capable of greatly reducing waiting time at a deli counter or sliced-meat department, providing the user more time for further shopping.

While the invention has been described in terms of specific or particular embodiments, it is apparent that other forms could be adopted by one skilled in the art. For example, the sales display devices and their identifying features could differ in appearance and construction from the embodiments described herein and shown in the drawings, functions of certain components of the device could be performed by components of different construction but capable of a similar (though not necessarily equivalent) function, and appropriate materials could be substituted for those noted. In addition, the invention encompasses additional or alternative embodiments in which one or more features or aspects of different disclosed embodiments may be combined. Accordingly, it should be understood that the invention is not necessarily limited to any embodiment described herein or illustrated in the drawings. It should also be understood that the phraseology and terminology employed above are for the purpose of describing the illustrated embodiments, and do not necessarily serve as limitations to the scope of the invention. Therefore, the scope of the invention is to be limited only by the following claims.

1. A slice thickness gauging device for use when purchasing a sliced food product, the slice thickness gauging device comprising:
a plurality of identifying features each having a thickness indicative of a different slice thickness of the sliced food product; and
means for individually identifying each of the plurality of identifying features.

2. The slice thickness gauging device of claim 1, wherein the identifying features comprise slots defined in an edge of a support and the identifying means comprises at least one of widths, colors, sizes, and logical order of the slots.

3. The slice thickness gauging device of claim 1, wherein the identifying features comprise disks protruding from slots in a support and the identifying means comprises at least one of thicknesses, colors, sizes, and logical order of the disks.

4. The slice thickness gauging device of claim 1, wherein the identifying features comprise sheet panels loosely secured to one another, and the identifying means comprises at least one of thicknesses, colors, sizes, and logical order of the panels.

5. The slice thickness gauging device of claim 1, wherein the identifying features comprise stacks of sheet panels adhesively secured to one another, and the identifying means comprises at least one of thicknesses, colors, sizes, and logical order of the panels.

6. The slice thickness gauging device of claim 5, wherein the sheet panels are disposable and the slice thickness gauging device is configured for a single use.

7. The slice thickness gauging device of claim 1, wherein the identifying features comprise a collection of rods secured to one another, and the identifying means comprises at least one of thicknesses, colors, sizes, and logical order of the rods.

8. The slice thickness gauging device of claim 1, wherein the identifying features are arranged in a logical order of increasing thickness to enable the customer to identify a slice thickness that is less than or greater than a identifying feature or between a consecutive pair of identifying features.

9. A disposable slice thickness gauging device produced as a copy or image of the slice thickness gauging device according to claim 1.

10. The slice thickness gauging device of claim 1, wherein the device is an order form and the identifying features are bands individually located within different color fields that function as the identifying means, the device further comprising an order number and a form field within which the customer is able to write the identity, weight, and slice thickness of the sliced food product, the order form being presentable to an attendant at a store counter to place an order for the sliced food product.

11. A method for purchasing sliced food products, the method comprising:
providing a slice thickness gauging device to a customer, the slice thickness gauging device having a plurality of identifying features each having a thickness representative of a slice thickness of which slices may be produced from a food product, the slice thickness gauging device having means for individually identifying each of the plurality of identifying features;
the customer comparing relative thicknesses of each of the plurality of identifying features, determining a desired slice thickness for the slices based on the relative thicknesses of each of the plurality of identifying features, and communicating the desired slice thickness based on the identifying means; and
cutting the product into the slices such that the slices have a slice thickness based on the desired slice thickness communicated by the customer.

12. The method of claim 11, wherein the identifying features are arranged in a logical order of increasing thicknesses and the customer identifies a slice thickness that is less than or greater than one of the identifying features or between a consecutive pair of the identifying features.

13. The method of claim 11, wherein the slice thickness gauging device is an order form and the identifying features are bands individually identified with the identifying means, the device further comprising an order number and a form field within which the customer is able to write the identity, weight, and the desired slice thickness of the sliced food product, the method further comprising:
the customer using the form field to identify the food product and the weight of the food product and selecting one of the identifying means to select the desired slice thickness;
the customer presenting the order form to an attendant at a store counter to place an order for the sliced food product; and
the attendant using the order number to notify the customer when the order if filled;
wherein the method reduces waiting time of the customer at the counter.

14. The method of claim 13, wherein the identifying means comprise multiple different color fields within which the bands are individually located.

15. A food product ordering system comprising:
an electronic device for placing an order for a sliced food product, the electronic device comprising a plurality of identifying features and means for individually identifying each of the plurality of identifying features, each of the identifying features having a thickness indicative of a slice thickness of the sliced food product, the electronic device further comprising means for selecting a food product, weight of the food product, and one of the identifying means to select one of the slice thicknesses; and
a computer wirelessly connected to the electronic device for receiving the order for the sliced food product.

16. The food product ordering system of claim 15, wherein the electronic device is a handheld electronic device.

17. The food product ordering system of claim 15, wherein the identifying features comprise bars displayed on the electronic device, and the bars are individually located within different color fields that function as the identifying means.

18. A method for purchasing the sliced food product with the food product ordering system of claim 15, the method comprising:
providing the electronic device to a customer;
the customer comparing relative thicknesses of the identifying features to determine a desired slice thickness for the sliced food product;
the customer selecting one of the identifying means corresponding to the desired slice thickness;
wirelessly communicating the identifying means to an attendant; and
the attendant cutting a food product to produce the sliced food product having the desired slice thickness.

19. The method of claim 18, wherein the identifying features comprise bars that are displayed on the electronic device and are individually identified with the identifying means.

20. The method of claim 19, wherein the bars are individually located within different color fields that function as the identifying means.
